(19) United States
(12) Patent Application Publication
(10) Pub. No.: US 2004/0172234 A1
(43) Pub. Date: Sep. 2, 2004

(54) Hardware accelerator personality compiler

(76) Inventors: Michael C. Dapp, Endwell, NY (US); Sai Lun Ng, Vestal, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/677,744

(22) Filed: Oct. 3, 2003

Related U.S. Application Data
(60) Provisional application No. 60/450,320, filed on Feb. 28, 2003.

(51) Int. Cl. G06F 17/20

(52) U.S. Cl. 704/1

(57) ABSTRACT

Error-free state tables are automatically generated from a specification of a group of desired performable functions, such as are provided in a programming language in a formal notation such as Backus-Naur form or a derivative thereof by discriminating tokens corresponding to respective performable functions, identifications, arguments, syntax, grammar rules, special symbols and the like. The tokens may be recursive (e.g. infinite), in which case they are transformed into a finite automata which may be deterministic or non-deterministic. Non-deterministic finite automata are transformed into deterministic finite automata and then into state transitions which are used to build a state table which can then be stored or, preferably, loaded into a finite state machine of a hardware parser accelerator to define its personality.

### CROSS-REFERENCE TO RELATED APPLICATIONS

This application claims priority of U.S. Provisional Patent Application 60/450,320, filed Feb. 28, 2003, which is hereby fully incorporated by reference.

### BACKGROUND OF THE INVENTION

1. Field of the Invention

The present invention generally relates to processing of applications and documents for controlling the operations of general purpose computers and, more particularly, to performing parsing operations on applications programs, documents and/or other logical sequences of symbols in a given but arbitrary language or format.

2. Description of the Prior Art

The field of digital communications between computers and the linking of computers into networks has developed rapidly in recent years, similar, in many ways to the proliferation of personal computers of a few years earlier. This increase in interconnectivity and the possibility of remote processing has greatly increased the effective capability and functionality of individual computers in such networked systems. Nevertheless, the variety of uses of individual computers and systems, references of their users and the state of the art when computers are placed into service has resulted in a substantial degree of variety of capabilities and configurations of individual machines and their operating systems, collectively referred to as “platforms” which are generally incompatible with each other to some degree particularly at the level of operating system and programming language.

This incompatibility of platform characteristics and the simultaneous requirement for the capability of communication and remote processing and a sufficient degree of compatibility to support it has resulted in the development of object oriented programming (which accommodates the concept of assembling an application as well as data as a group of more or less generalized modules through a referencing system of entities, attributes and relationships) and a number of programming languages to embody it. Extensible Markup Language™ (XML™) is such a language which has come into widespread use and can be transmitted as a document over a network of arbitrary construction and architecture.

In such a language, certain character strings correspond to certain commands or identifications, including special characters and other important data (collectively referred to as control words) which allow data or operations to, in effect, identify themselves so that they may be thereafter treated as “objects” such that associated data and commands can be translated into the appropriate formats and commands of different applications in different languages in order to engender a degree of compatibility of respective connected platforms sufficient to support the desired processing at a given machine. The detection of these character strings is performed by an operation known as parsing, similar to the more conventional usage of resolving the syntax of an expression, such as a sentence, into its component parts and describing them grammatically. Even in other computer programming languages and documents which can be searched or otherwise processed by a computer, control words will be limited to a finite but possibly large number and thus allowable sequences of symbols will be similarly limited as an incident of the content and grammar of the language. Moreover, parsing of a document to identify its contents has proven to be an important tool for providing security in processors and networks through detection of control words which may represent an attack, unauthorized access or other possible breach of security. Additionally, many other devices such as telephonic and/or diagnostic equipment having more or less complex sequences of functions employ finite state machines to achieve different functions in response to similar stimuli or inputs depending on a sequence of prior functions while, as a practical matter, the customization of response of many such devices is increasingly demanded but limited by the difficulty of generating state tables corresponding to desired sequences of responses to inputs.

When parsing an XM™ document, for example, a large portion and possibly a majority of the central processor unit (CPU) execution time is spent traversing the document searching for control words, special characters and other important data as defined for the particular XML™ standard being processed. This is typically done by software which queries each character and determines if it belongs to the predefined set of strings of interest, for example, a set of character strings comprising the following “<command>”, “<data=dataword>”, “<endcommand>”, etc. If any of the target strings are detected, a token is saved with a pointer to the location in the document for the start of the token and the length of the token. These tokens are accumulated until the entire document has been parsed.

The conventional approach to parsing a document is to implement a table-based finite state machine (FSM) in software to search for these strings of interest. The state table resides in memory and is designed to search for the specific patterns of interest in the document. The current state is used as the base address into the state table and the ASCII representation of the input character is an index into the table. For example, assume the state machine is in state 0 (zero) and the first input character is ASCII value 02, the absolute address for the state entry would be the sum/concatenation of the base address (state 0) and the index/ASCII character (02). The FSM begins with the CPU fetching the first character of the input document from memory. The CPU then constructs the absolute address into the state table in memory corresponding to the initialized/current state and the input character and then fetches the state data from the state table. Based on the state data that is returned, the CPU updates the current state to the new value, if different (indicating that the character corresponds to the first character of a string of interest) and performs any other action indicated in the state data (e.g. issuing a token or an interrupt if the single character is a special character or if the current character is found, upon a further repetition of the foregoing, to be the last character of a string of interest).

The above process is repeated and the state is changed as successive characters of a string of interest are found. That is, if the initial character is of interest as being the initial character of a string of interest, the state of the FSM can be advanced to a new state (e.g. from initial state 0 to state 1). If the character is not of interest, the state machine would (generally) remain the same by specifying the same state (e.g. state 0) or not commanding a state update) in the state table entry that is returned from the state table address. Possible actions include, but are not limited to, setting interrupts, storing tokens and updating pointers. The process is then repeated with the following character. It should be noted that while a string of interest is being followed and the FSM is in a state other than state 0 (or other state indicating that a string of interest has not yet been found or currently being followed) a character may be found which is not consistent with a current string but is an initial character of another string of interest. In such a case, state table entries would indicate appropriate action to indicate and identify the string fragment or portion previously being followed and to follow the possible new string of interest until the new string is completely identified or found not to be a string of interest. In other words, strings of interest may be nested and the state machine must be able to detect a string of interest within another string of interest, and so on. This may require the CPU to traverse portions of the XML™ document numerous times to completely parse the XML™ document.

It can be readily understood, however, that the state table of the FSM must be specific to a given computer language and the control words and/or grammar and syntax thereof. It can also be appreciated that the extent of the state table must become very large with increasing numbers of control words and format rules. Moreover, it is common at the present time to generate enhanced or extended versions of even well-established and industry-standard languages with increasing frequency and any revision or extension of any computer language necessarily requires a corresponding revision of the state table of an FSM used to parse a document in that language. In other words, all allowable combinations of symbols presented by control words must be reflected in the state table and seemingly small revisions or extensions of the control word set and/or language grammar may entail substantial revision or increase in size of the state table of the FSM.

It has been the practice to generate these state tables manually and to load them into memory accessible by the FSM in order to accommodate changes in the language while avoiding changes to the hardware of the FSM. The language to which the FSM is directed and the capability of the FSM to parse a document in that language is sometimes referred to as “personality” of the FSM. No practical alternative to a manual state table generation process for altering the personality of an FSM has existed, even though the development of a state table may comprise a substantial portion of the development expense of a computer language or applications employing that language. Further, as with all manual processes, manual generation of a state table is subject to errors which must be detected and corrected before the FSM can be reliably used. It practical effect, where parsing of a document is required, the time required for development of the state table causes delay in implementation of software applications and modifications, extensions and upgrades thereof even though such language modifications, extensions and upgrades are becoming increasingly frequent in modern processor and network environments. Moreover, where parsing of a document is used as a tool for detection of a possible security breach, additions of strings of interest to the state table should be added in as timely a manner as possible as strings indicating such a possible security breach are recognized as such even though such an addition may require a substantial revision of the state table used for such a purpose. More generally, any circumstance in which it may be desirable to modify the personality of a FSM to alter the function of a device including the FSM could benefit from a reduction in difficulty, cost and susceptibility of errors in generating corresponding state tables.

### SUMMARY OF THE INVENTION

It is therefore an object of the present invention to provide a technique and apparatus for simple and error-free alteration of state tables of finite state machines.

It is another object of the invention to provide a technique and apparatus for reconfiguring finite state machines and devices such as hardware parser accelerators which include finite state machines without making hardware modifications particularly to accommodate computer language and application modifications and extensions or entirely new computer language and/or application specifications.

It is a further object of the invention to provide a method and apparatus for producing state transition tables and recording them in a self-describing data format such as XML™.

In order to accomplish these and other objects of the invention, the invention provides a methodology and a compiler for performing the method and loader, preferably implemented in software within an arrangement such as a hardware parser accelerator, which can read a language specification or specification summarizing desired performable functions to produce an output which can be loaded into a memory accessible by a device, such as a parsing accelerator, including a finite state machine (FSM) in order to customize the personality of the FSM and, in turn, the device including the FSM. The language or other specification is preferably written in a formal notation such as the Backus-Naur Form (BNF) or its derivatives or other regular expressions. Based on such input, the compiler in accordance with the invention generates the corresponding state transitions to form a state transition specification comprising one or more state tables.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a high level schematic block diagram of the invention,

FIG. 2A is a diagram representing a state table useful in understanding the invention,

FIG. 2B is a high level flow chart showing the basic operation of a generalized form of the invention,

FIG. 3 is a high level flow chart showing the operation of a preferred embodiment of the invention,

FIG. 4 is a high level context diagram of the preferred embodiment of the invention,

FIGS. 5A, 5B, 5C, 5D, 5E, 5F, 5G, 5H and 5I illustrate grouping and recognizing sub-expressions in grammar rule definitions, and

FIG. 6, comprising FIGS. 6A and 6B, illustrates an example of an output state table specification file represented completely in a self-describing data format.

### DETAILED DESCRIPTION OF A PREFERRED EMBODIMENT OF THE INVENTION

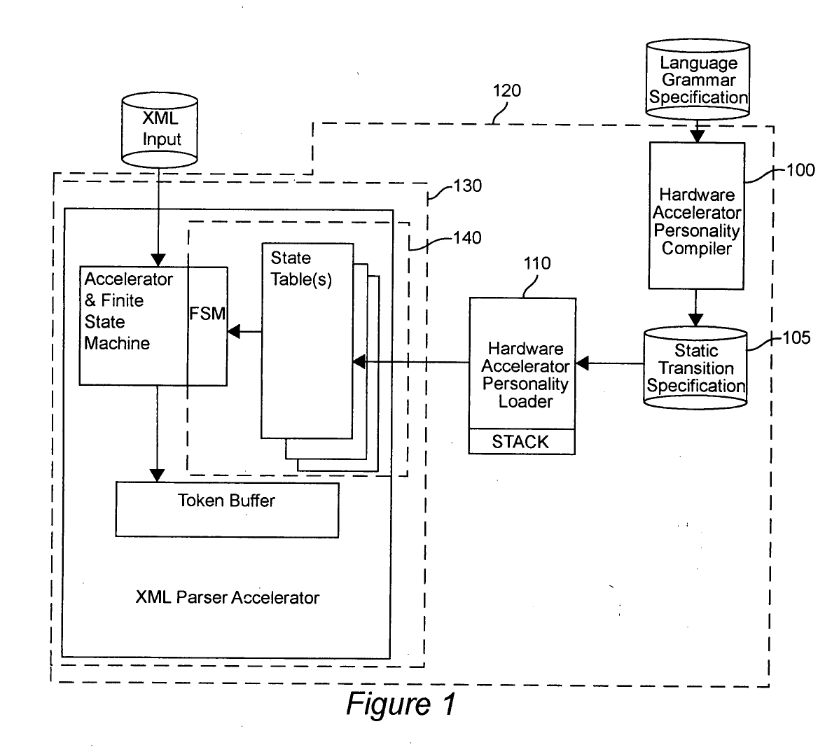

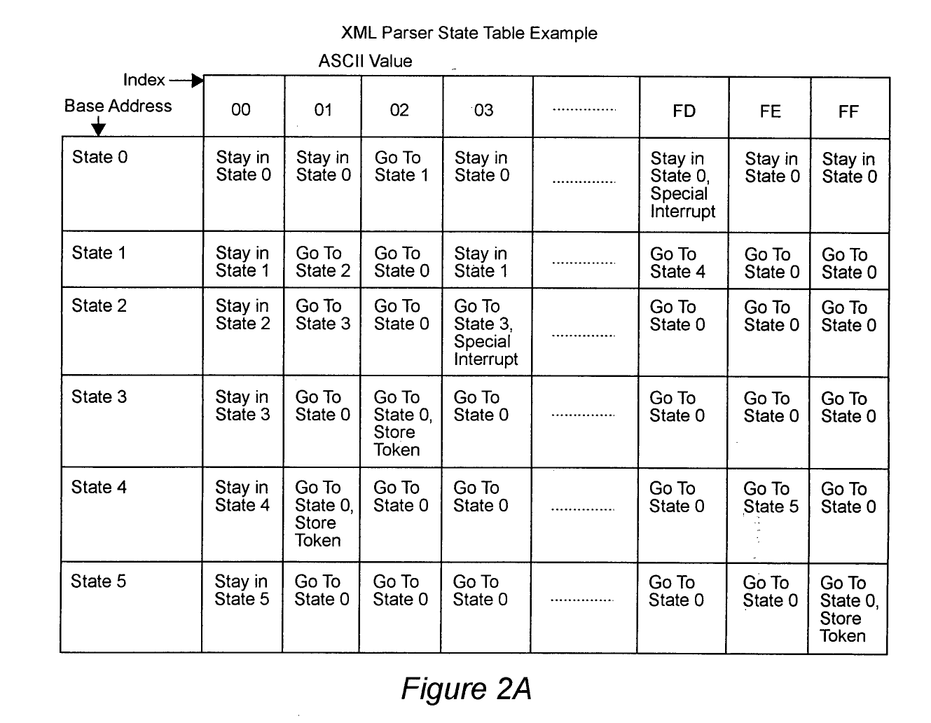

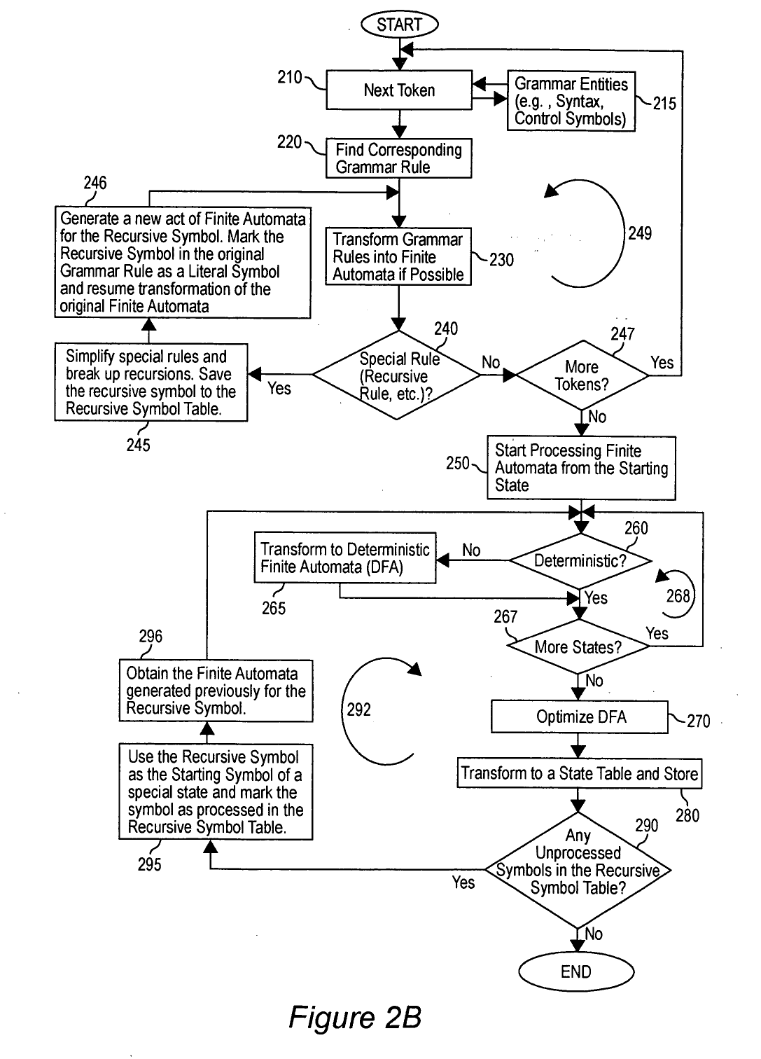

Referring now to the drawings, and more particularly to FIG. 1, there is shown a high level schematic block diagram of a basic form of the personality compiler in accordance with the invention and connected to provide state tables to a finite state machine (FSM) in a device, preferably a hardware parsing accelerator. Initially, it should be noted that the personality compiler 100 can be implemented as a stand-alone device which can be connected to a memory 105 (e.g. with a hardware parser accelerator off-line) which can then be accessed to obtain a state transition specification to be loaded, when needed on an on-demand basis, into the state tables of an FSM by a loader 110 or integrated with a FSM 140 in an arbitrary device (indicated by dashed line 120) to be partially or wholly controlled thereby, allowing the personality of the device to be updated in real time or substantially so. (It should be appreciated in this latter case, that the operation of the invention in substantially real time, particularly by accelerating real-time operation through compiling an alternate version of a language grammar specification, allows it to adapt over time to patterns and conditions encountered in the input stream(s); thus providing a rudimentary learning capability in the personality compiler as well as in the device including the FSM. By the same token, it should be appreciated that parts of the process which will be described below and which yield intermediate results, such as preprocessing of the grammar specification (e.g. up to step 250 of FIG. 2B or to provide pre-generated state tables which are archivally stored) may be operated in a stand-alone fashion and the processing continued from stored data (e.g. finite automata or state tables) when needed. The preferred application and environment of the invention is in connection with a hardware accelerator as depicted by dashed line 130 in either an integrated or a wholly or partially stand-alone configuration.

Regardless of the implementation of the invention, it will be useful to an understanding of the invention to review the nature of a state table for a FSM, particularly in regard to the preferred environment of a hardware parser accelerator. Three different implementations of hardware parser accelerators are respectively disclosed in U.S. patent applications Ser. Nos. 10/______,______ , 10/______,______ and 10/______,______ (Attorney's Docket Numbers FS-00766, FS-00767 and FS-00768) all filed on Dec. 31, 2002, and assigned to the assignee of the present invention and which are all hereby fully incorporated by reference. FIG. 2A illustrates a portion of an exemplary state table as disclosed therein.

It should be understood that the state table shown in FIG. 2A is potentially only a very small portion of a state table useful for parsing a document and is intended to be exemplary in nature. While the full state table does not usually physically exist, at least in the form shown, and FIG. 2A can also be used in facilitating an understanding of the operation of known software parsers, no portion of FIG. 2A is admitted to be prior art in regard to the present invention.

It should be noted that an XML™ document is used herein as an example of one type of logical data sequence which can be processed using an accelerator in accordance with the invention. Other logical data sequences can also be constructed from network data packet contents such as user terminal command strings intended for execution by shared server computers. (Such command strings are frequently generated by malicious users and sent to shared server computers as part of a longer term intrusion attempt.) The accelerator in accordance with the invention is suitable for processing many such logical data sequences. It will also be helpful observe that many entries in the portion of the state table illustrated in FIG. 1 are duplicative.

It is convenient and preferred that the hexadecimal representation of a symbol be used as an index into the state table and the vertical columns thereof are accordingly labelled “00” to “FF”. the rows are numbered to reflect the various states which the FSM can assume. The rows of the base address are thus divided into a number of columns corresponding to the number of codes which may be used to represent characters in the document to be parsed; in this example, two hundred fifty-six (256) columns corresponding to a basic eight bit hexadecimal byte for a character. As many characters as may be required, printable or non-printable, may be accommodated in this fashion.

It will be helpful to note several aspects of the state table entries shown, particularly in conveying an understanding of how even the small portion of the exemplary state table illustrated in FIG. 1 supports the detection of many words:

1. In the state table shown, only two entries in the row for state 0 include an entry other than “stay in state 0” which maintains the initial state when the character being tested does not match the initial character of any string of interest. The single entry which provides for progress to state 1 corresponds to a special case where all strings of interest begin with the same character. Any other character that would provide progress to another state would generally but not necessarily progress to a state other than state 1 but a further reference to the same state that could be reached through another character may be useful to, for example, detect nested strings. The inclusion of a command (e.g. “special interrupt”) with “stay in state 0” illustrated at {state 0, FD} would be used to detect and operate on special single characters.

2. In states above state 0, an entry of “stay in state n” provides for the state to be maintained through potentially long runs of one or more characters such as might be encountered, for example, in numerical arguments of commands, as is commonly encountered. The invention provides special handling of this type of character string to provide enhanced acceleration, as will be discussed in detail below.

3. In states above state 0, an entry of “go to state 0” signifies detection of a character which distinguishes the string from any string of interest, regardless of how many matching characters have previously been detected and returns the parsing process to the initial/default state to begin searching for another string of interest. (For this reason, the “go to state 0” entry will generally be, by far, the most frequent or numerous entry in the state table.) Returning to state 0 may require the parsing operation to return to a character in the document subsequent to the character which began the string being followed at the time the distinguishing character was detected.

4. An entry including a command with “go to state 0 indicates completion of detection of a complete string of interest. In general, the command will be to store a token (with an address and length of the token) which thereafter allows the string to be treated as an object. However, a command with “go to state n” provides for launching of an operation at an intermediate point while continuing to follow a string which could potentially match a string of interest.

5. To avoid ambiguity at any point where the search branches between two strings of interest (e.g. strings having n−1 identical initial characters but different n-th characters, or different initial characters), it is generally necessary to proceed to different (e.g. non-consecutive) states, as illustrated at {state 1, 01} and {state1, FD}. Complete identification of a string of arbitrary length n will require n−1 states except for the special circumstances of included strings of special characters and strings of interest which have common initial characters. For these reason, the number of states and rows of the state table must usually be extremely large, even for relatively modest numbers of strings of interest.

7. Conversely to the previous paragraph, most states can be fully characterized by one or two unique entries and a default “go to state 0”. This feature of the state table of FIG. 1 is exploited in the invention to produce a high degree of hardware economy and substantial acceleration of the parsing process for the general case of strings of interest.

The parsing operation, as conventionally performed, begins with the system in a given default/initial state, depicted in FIG. 2A as state 0, and then progresses to higher numbered states as matching characters of a character string of interest are found upon repetitions of the process. When a string of interest has been completely identified or when a special operation is specified at an intermediate location in a string which is potentially a match, the operation such as storing a token or issuing an interrupt is performed. At each repetition for each character of the document, however, the character must be fetched from CPU memory, the state table entry must be fetched (again from CPU memory) and various pointers (e.g. to a character of the document and base address in the state table) and registers (e.g. to the initial matched character address and an accumulated length of the string) must be updated in sequential operations. The hardware parser accelerators disclosed in the above-incorporated applications accelerate the parsing process by providing for many of these operations to be performed in parallel while subsequent symbols of a document are being evaluated by the finite state machine therein.

In summary, the basic function of a parser is to uniquely recognize an input character (e.g. symbol or binary signal sequence) string of interest and issue a unique token and other information upon such recognition. Recognition of nested strings of interest must also be detected and validated in some cases and for some purposes. Therefore, it is important to recognize that all character strings which can result in the issuance of a token are incidents of the language of the document being parsed as defined by control words and the characteristic syntax of that language. Conversely, incidents of the language which are represented by control words and/or their arrangement in a sequence may also be regarded as tokens in regard to the language specification. It follows that the language specification contains sufficient information to define all character strings of interest that can result in the issuance of tokens by the parser for a given language or set of character strings of interest and is thus sufficient for generation of a state table to recognize them.

Referring now to FIG. 2B, a flow chart illustrating the operation of a generalized form of the invention is shown. Upon invoking the process, a “next token” is called, as shown at 210. It is assumed that some order will exist in the language specification if only in the serial order of the data in which it is expressed. The actual order, to the extent an order exists, may be arbitrary and, in any event, does not affect the usability of the state transition specifications which will be developed since the parser is arranged to recognize strings of interest in any order. The order of tokens may affect the assigned state numbers but those state number are of no practical consequence. That is, any string of interest will cause advancement through a sequence of states of the state table to arrive at a terminal state at which a string of interest will have been uniquely identified but the numbers of the states and their sequence have no effect on the result.

The calling of a “next token” thus functions to provide a mechanism to cause the consideration of the entire language specification by looping over the entire process until all tokens have been considered. Preferably, this operation is carried out by reading the grammar input file 215, identifying the grammar entities such as control words and syntax requirements for characters/symbols (e.g. branching statements, characters delimiting fields, and the like) and tokenizing them by assigning unique tokens to each identified entity. Particular matching rules or criteria (e.g. specifying numbers of arbitrary characters) may also be considered and applied in this process. These functions are collectively indicated at 220 of FIG. 2B.

This process will result in a set of transition diagrams, or finite automata (by which terminology such transition diagrams may be referenced hereinafter), as indicated at 230, for some grammar entities such as control words representing commands provided in the language while other grammar entities such as branching statements and delimiter symbols which are recursive will require additional processing and transformation to obtain character strings which can be expressed in a state table. Specifically, at 240, remaining grammar rules that have not been transformed into character strings are tested to determine if they are recursive or express other properties such as exclusion. If needed, in accordance with this test, the grammar rules are simplified to be expressed as a character string or expanded into expanded grammar rules at 245. At this point, a nested subprocess at 246 that duplicates the steps as indicated by the loop 249 is performed to generate a new set of finite automata for the recursive symbol. This recursive symbol becomes the starting state for the new set of finite automata, and any additional recursive symbols encountered within the nested subprocess will be treated as if they were literal symbols. Literal symbols are symbols that can be used directly as an input for a state transition. Before returning to the main processing step at 230, the new set of finite automata generated for the recursive symbol is saved away in memory for processing later, and the recursive symbol is marked as a literal symbol in the grammar rule so that it breaks up the recursion when the processing is returned to step 230. The process is then repeated by looping to 210, as indicated by the loop 249 alluded to above, until all grammar entities have been considered and processed to form a complete sequence of finite automata, or state transition diagrams.

Now, having the complete grammar of a language represented as a sequence of finite automata, the processing continues beginning with the starting state at 250. A state transition diagram is made up of nodes for states and label edges for transitions. The label edges identify two pieces of information: input (e.g. condition for transition) and next state. If the same input (e.g. a character) can cause multiple transitions, to different states, the finite automaton is known as non-deterministic. The transformation processing at 230 produces both non-deterministic finite automata (NFA) and deterministic finite automata (DFA). NFA is not suitable for building state tables for an FSM of a hardware accelerator. A check is performed at 260 to pick out the NFA. The NFA are then transformed into DFA at 265 by collapsing states that have certain properties into a closure set.

These states forming the closure set are thus combined and then replaced with a new state that represents the closure set. The state transitions are then adjusted with labelled edges going into and out of the new state. Suitable techniques for this transformation are known to those skilled in the art of compiler design and a textbook example is provided in “Principles of Compiler Design” by Aho and Ullman, Addison-Wesley Publishing Co., 1977, pp. 91-93. The transformation is repeated for additional states by the loop at 268. After all NFA are transformed into deterministic finite automata (DFA), the DFA can then be optimized at 270 and transformed at 280 to state table data for storage in a mass store before loading into a FSM or directly loaded into a FSM.

Now that the states and their transitions for the main portion of the language is complete, the process to transform finite automata into a state table is repeated at the loop 292 for each of the recursive symbols identified at 245. At 290, each of the recursive symbols in the Recursive Symbol Table having finite automata that have not been transformed into a state table is identified. A new state table is initialized specifically for the recursive symbol at 295. This new state table does not have to be a separate table physically. It can be appended to the state table for the main portion of the language generated earlier. To simplify the description herein, it is logically viewed as a separate new state table. The finite automata created previously for the recursive symbol are gathered together at 296 so that the same process to transform the finite automata into a state table can be performed again with the steps starting from 260. The loop at 292 repeats until all recursive symbols are transformed into state tables.

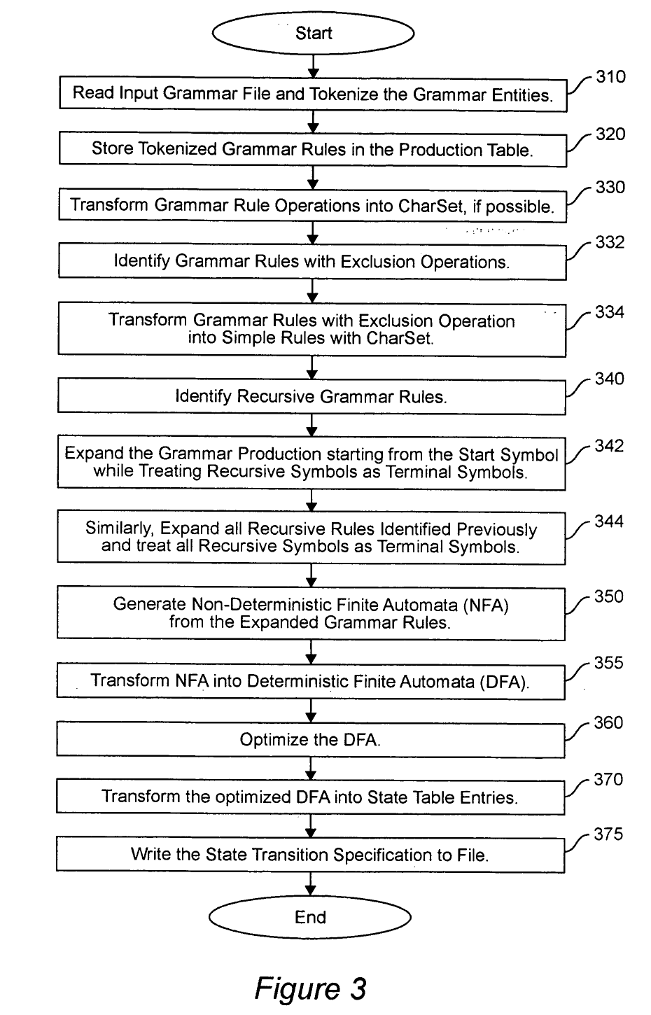

With the foregoing as a summary of a generalized form of the invention, a preferred embodiment of the invention will now be described with reference to FIGS. 3 to 6. The preferred embodiment is directed to generation of state tables directed to particular forms of XML™. However, it should be understood that the invention may be employed in various forms and embodiments and for different purposes such as for detecting potential security breach attempts (which may employ some commands in any of a plurality of computer languages) or discrimination of only particular commands, syntax or the like.

It will be appreciated by those skilled in the art that the operations of the preferred embodiment of the invention illustrated in FIG. 3 is substantially an expansion of the generalized flow chart of FIG. 2B. Additionally, the operations of FIG. 3 are illustrated as sequential and without branching operations, as is preferable for rapid execution while being sufficient to accommodate XML™. To further accelerate the processing, some branching is avoided by, preferably, providing intermediate and temporary storage in a production table so that only grammar entities requiring further processing remain in the processing stream.

Once the process is initiated, the grammar file is read and the grammar entities are identified and tokenized as illustrated at 310. The tokenized grammar rules are then stored in a production table, as illustrated at 320. the grammar rule operations are then transformed into character strings (CharSet) insofar as is possible, as illustrated at 330.

As alluded to above, the grammar file is preferably expressed in a formal notation such as Backus-Naur Form (BNF) or a derivative thereof such as Extended Backus-Naur form (EBNF). XML™ is documented in this form by the World Wide Web Consortium and is widely available in electronic form. A summary description of the EBNF notation is as follows:

A language is made up of symbols with a set of rules (grammar) that govern how they can be correctly combined together. Each EBNF grammar rule is specified as follows:

symbol::=expression

A language starts with a start symbol, and the symbol is defined with the right hand side expression as shown in the above notation using additional symbols, descriptors, attributes, and operators. New symbols are defined in the subsequent rules until all symbols for the language are defined.

The symbol descriptors, attributes and operators that can appear on the right hand side expressions are defined as follows:

#xN

where N is a hexadecimal integer, the expression matches the character in ISO/IEC 10646 whose canonical (UCS-4) code value, when interpreted as an unsigned binary number, has the value indicated. The number of leading zeros in the #xN form is insignificant; the number of leading zeros in the corresponding code value is governed by the character encoding in use and is not significant.

[a-zA-Z], [#xN-#xN]

matches any character with a value in the inclusive range(s) indicated.

[abc], [#xN#xN#xN]

matches any character with a value among the characters enumerated. Enumerations and ranges can be mixed in one set of brackets.

[\hat{ }a-z], [\hat{ }#xN-#xN]

matches any character with a value not among the characters given. Enumerations and ranges of forbidden values can be mixed in one set of brackets.

“string”

matches a literal string inside the double quotes.

‘string’

matches a literal string inside the single quotes.

These symbols may be combined to match more complex patterns as follows, where A and B represent simple expressions:

(expression)

expression is treated as a unit and may be combined as described in this list.

A?

matches A or nothing; optional A.

A B

matches A followed by B. This operator has higher precedence than alternation; thus A B|C D is identical to (A B)|(C D)

A|B

matches A or B but not both; also known as alternation.

A-B

matches any string that matches A but does not match B; (A excludes B).

A+

matches one or more occurrences of A. Concatenation has higher precedence than alternation; thus A+|B+ is identical to (A+)|(B+)

A*

matches zero or more occurrences of A.

Concatenation has higher precedence than alternation; thus A*|B*is identical to (A*)|(B*).

Other notations used in the productions (or set of rules):

/* . . . */

comment

An example of using the above notations to define an XML™ “Name” is as follows:

Namechar::=Letter|Digit|‘·’|‘−’|‘_’|‘:’

Name::=(Letter|‘_’|‘:’)(Namechar)*

Assuming ‘Letter’ means the alphabetic characters and ‘Digit’ means the numeric characters 0-9, an XML™ ‘Name’ is a sequence of characters which begins with an alphabet, an underscore or a colon and followed by zero or more ‘Namechar’. A ‘Namechar’ is either an alphabetic character, a numeric character, a period, a dash, an underscore or a colon.

It will be appreciated that some of the foregoing notations specify exclusion operations (e.g. A-B). These notations are discriminated at 332 and transformed into simple rules that can be expressed as a CharSet character string as illustrated at 334. Next, the recursive grammar rules are identified at 340. For example, consider the following two XML™ grammar rules:

cp::=(Name|choice|seq) (‘?’|‘*’|‘+’)?

choice::=‘(‘S? cp(S?’|‘S?cp)+S?’)’.

The expansions for both “cp” and “choice” refer to each other. Substituting the symbol “cp” or “choice” on the right hand side of the grammar rule expression with their definition will result in an infinite length expression due to recursion created by the grammar rules of cp and choice referring to each another. These rules are expanded, preferably in temporary storage which can be discarded after the grammar is transformed into a set of finite automata, at 342 from Grammar Production from the start symbol, treating the recursive symbols at the moment as a special literal symbol. A literal symbol is a symbol that can be used by itself as an input for a state transition. This will result in a complete continuous grammar rule for the entire language. The recursive symbols that are temporarily treated here as literal symbols will be handled at 344.

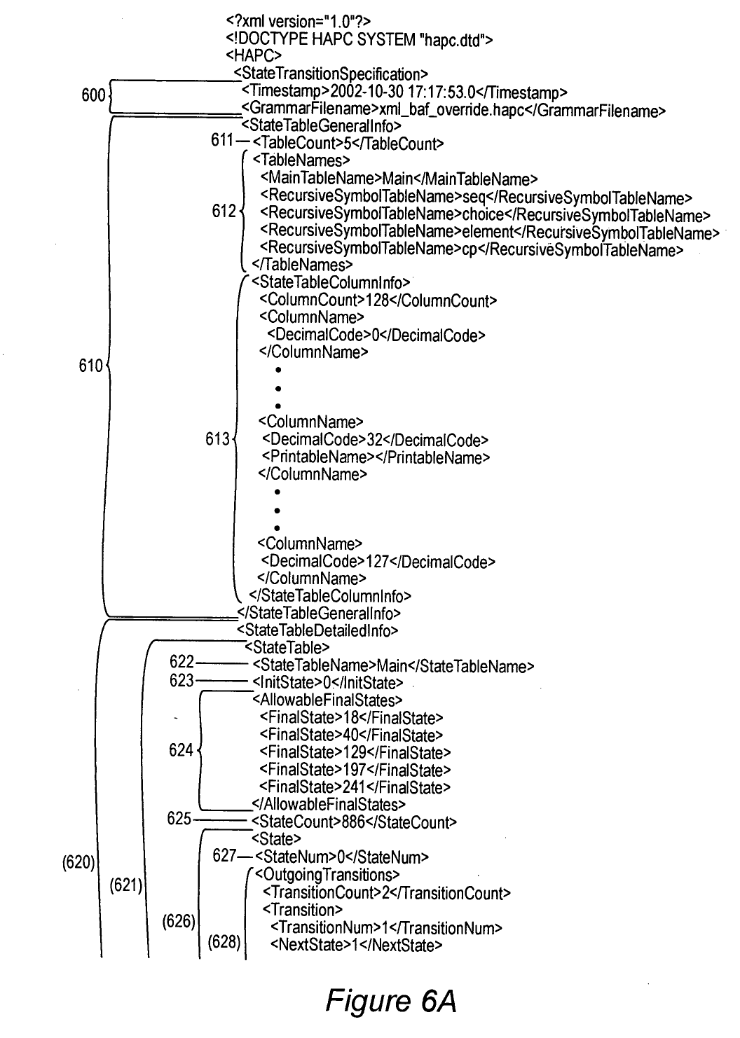

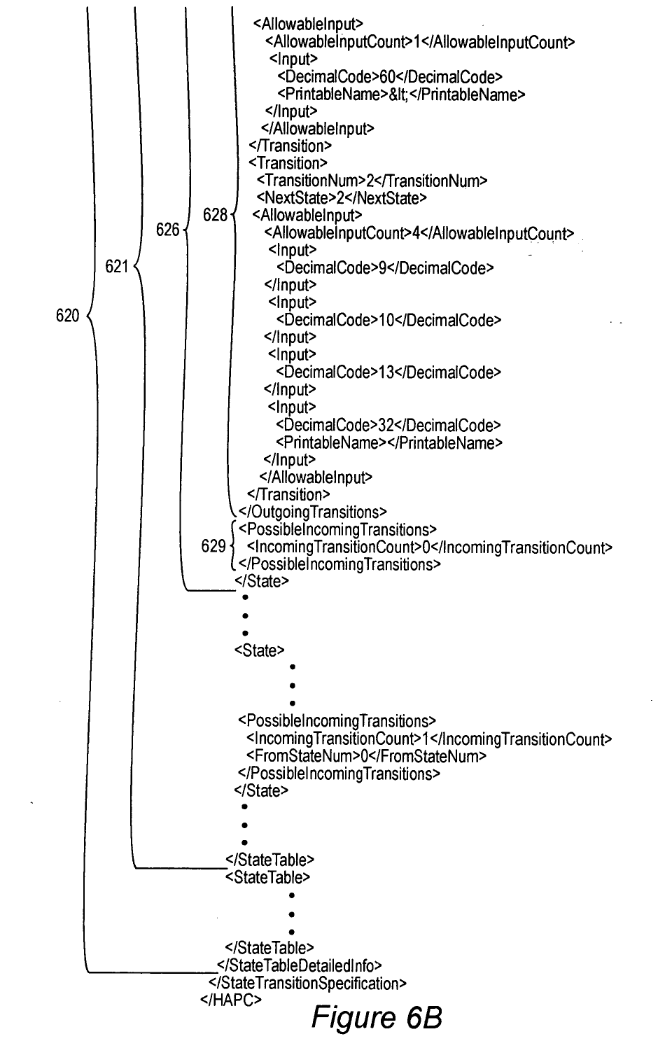

At 344, each of the previously identified recursive symbols is used as a starting symbol for a new expansion that will end up with a complete continuous grammar rule for the recursive symbol. It enables a new set of finite automata to be generated specifically for each of the recursive symbols. A set of states associated with these recursive symbols will be generated later in the process based on the finite automata created at this step. To further explain how the recursive symbols are being handled after they are transformed into states, we will briefly describe a function within the loader (110 in FIG. 1) here. The loader populates the state table(s) within the hardware accelerator FSM according to the state information produced by the Hardware Accelerator Personality Compiler (HAPC). In addition to state identifications and state transitions, the HAPC also identifies all recursive symbols to the loader as shown in FIG. 6. When the loader processes a state transition involving a recursive symbol, it recognizes the recursive symbol. Instead of having the FSM to go to the next state immediately, the loader loads commands into the FSM as actions for this particular transition to push the next state information on to the stack within the hardware accelerator and branch to the starting state of the grammar rule for the recursive symbol. For each of the terminal states in the grammar for the recursive symbol, the loader loads commands as actions for the terminal states in the FSM to pop the state information off the stack and go to the next state that is popped off from the stack. If recursive symbols that are embedded as input within the states for a recursive symbol grammar rule are encountered, the loader performs the same operations as just described. The stack within the hardware accelerator enables the handling of these nested state transitions as a result of having recursive definition in the grammar rule.

Non-deterministic finite automata (NFA) are then generated from the expanded grammar rules (350) and transformed into deterministic finite automata (DFA) as illustrated at 355 as discussed above. The DFA can then be optimized (360) and the optimized DFA transformed into state table entries (370) which are then stored as discussed above.

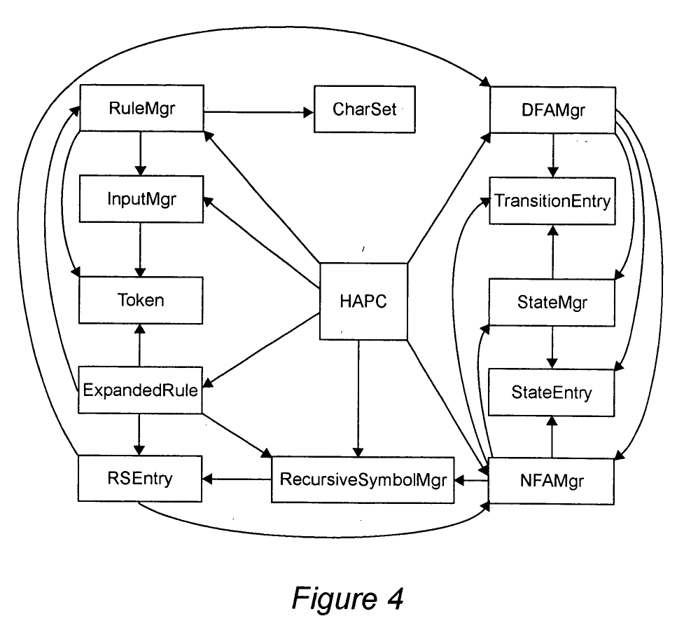

It is preferred to provide the above operations as software objects in accordance with the concept of object oriented programming. As is well-understood in the art, objects are essentially modules of a larger program which encapsulate and hide the details of their operations (which are irrelevant to the function of the overall function of the program and the interaction of the objects themselves) while the objects are able to call other objects, as needed, to carry out the program. The objects also can be arranged into classes which have relationships forming a context which is illustrated in FIG. 4. In the following descriptions of classes of software objects and the objects therein, the descriptions of the objects and their functions which are provided are sufficient to the successful practice of the invention and further details thereof which are encapsulated by the objects are not important to the successful practice of the invention.

As illustrated in FIG. 4, the hardware accelerator personality compiler (HAPC) in accordance with the invention comprises a main HAPC class and twelve additional classes:

1. InputMgr

2. Token

3. RuleMgr

4. ExpandedRule

5. CharSet

6. RecursiveSymbolMgr

7. RSEntry

8. NFAMgr

9. StateMgr

10. StateEntry

11. TransitionEntry

12. DFAMgr

which will be discussed, in order below.

The HAPC class contains the main program, and methods to direct the execution from reading the input, doing the compilation processing, and writing the output. The InputMgr class object is responsible to tokenize the input from a grammar rule specification file. The Token class object defines the supported token categories and provides support to access, set, and update tokens. The RuleMgr class object organizes the tokenized grammar production rules in a hash table allowing the software to have quick access to the grammar rules. The CharSet class object provides special support for character set entities in a grammar rule. The ExpandedRule class object provides a facility to refine grammar rules into a continuous rule for a language starting from a specific token. The RecursiveSymbolMgr class object provides a repository to identify symbols that are used recursively in the grammar rule definitions. The RSEntry class object defines recursive symbol repository entry format. The NFAMgr class object provides support to create a non-deterministic finite automata from a grammar rule. The StateMgr class object manages a repository that contains state transition information which is used for the creation of the state table(s). The StateEntry class object defines the format used for entries in the state repository. The TransitionEntry class object provides a facility to store the state transition information. The DFAMgr class object provides support to convert a non-deterministic finite automata into a deterministic finite automata that is suitable for state table generation. HAPC

The Hardware Accelerator Personality Compiler (HAPC) class contains the main program to start off the whole compilation process. In addtion to the main method, the class contains the following methods:

genStates

writeStateTransitions

timestampToString

The genStates method is the main driver of the compilation process. It creates and interfaces with other class objects to read the input grammar specification, process the grammar specification information into finite states, and write the state transition information out to a file.

The writeStateTransition method creates an output stream for the state transition specification produced by the HAPC, and write out the information to the output file.

The timestampToString method is a utility method supporting the writeStateTransition method to format the timestamp information into a printable string.

InputMgr

The Hardware Accelerator Personality Compiler Input Manager, InputMgr, is responsible for reading the input file that contains rules for a language grammar and encoding the input rule data as tokens. Information in the input file is broken up into tokens so that they are readily identifiable by their category. The InputMgr class supports the following constructor and methods:

InputMgr

next_token

startNewSection

next_line

parseCharLiteral

The InputMgr constructor sets up the Java Buffer Reader to read in the Input Grammar Rule file. The Input Grammar Rule file consists of three sections: User Directives, Production Rule, and Production Rule Overrides. These three sections are separated from each other by a line that starts with and contains only the two characters: %%. The User Directives section appears first at the beginning of the file. All user directive keywords are prefixed with the “%” character. Currently, the only supported user directive is % StartSymbol which has one argument. The argument specifies the starting symbol for the language that is defined in the Production Rule section. Comments which are enclosed within the symbol set:/*and*/can appear anywhere inside the input file. The Production Rule section contains the grammar rules for the language to be processed. Currently, it is assumed that the grammar rules are represented in the EBNF format. All left hand side symbols of the production rules must start in column 1. A production rule may span over a number of lines. All continuation lines must start with at least a blank character at column 1. The Production Rule Overrides section is the last and optional section. It allows the user to re-specify some of the production rules that appeared earlier in the Production Rule section. This allows the user to specify all grammar rules as they were defined by the creator of a language without any changes in the Production Rule section. If certain rules have notations that cannot be processed automatically by this software, the user can re-specify those rules using only notations supported by this software in the Production Rule Overrides section.

After invoking the InputMgr constructor, the Hardware Accelerator Personality Compiler software can start extracting the entire input grammar production rules from the input file one token at a time by invoking the next_token method repeatedly. Each token is initially formed by recognizing the delimiter characters in the input character stream created from the input file. The token is then classified into different token categories. These token categories are described in further detail in the Token section. The InputMgr handles formatting information transparently and skips all comments in the input file. Character literals which are specified as numeric values in the input file are converted into character values internally via the parseCharLiteral method before it is being tokenized.

The startNewSection is a simple method allowing a caller to reset the InputMgr from the “end of the rule section” state and thus allowing the software to read in additional production rules to override some of the previous grammar rule specifications.

The constructor, the startNewSection and the next_token methods are the primary external interfaces into the InputMgr class object. Other private methods implemented in the InputMgr class are: next_line, and parserCharLiteral. The private method, next_line, gets a line of characters from the input file and returns a trimmed version of the input line to the caller. It keeps a line count for the input file, and it trims off the blank spaces at the beginning and at the end of an input line. The other private method is parseCharLiteral. It converts a character literal represented as a hexadecimal number into an internal ASCII character. This allows the non-printable characters to be processed within the software in the same way as the printable characters.

Token

The Token class provides a facility to create and maintain tokens. By breaking the input character stream into tokens, the software can easily classify each logical character sequence within the input file and process the information accordingly. There are 7 major token categories: Control; Symbol; Operator; Attribute; Group; Misc; and Unknown.

The most important token within the Control category is End Of File (EOF), which indicates to the software that the end of the input file has been reached. There are also a few other tokens defined in this category, however, they are only for transient use within the software. Since they are unimportant to the practice of the invention in accordance with its basic principles, they will not be detailed here.

Tokens belonging to the Symbol category include: StrProd (Start Production), Symbol (regular grammar symbol), RecursiveSymbol, Literal, Set, and CharSet. The StrProd token is created to store the name of a new grammar rule. The Symbol token denotes a general grammar rule symbol. A RecursiveSymbol is a token that is reclassified from a general Symbol token after the software determines that the symbol has been used recursively in the grammar rules. Single characters, numeric representation of characters, and character strings are marked as literals when they are tokenized. Numeric representation of characters are converted into regular ASCII characters before they are tokenized. By doing it this way, all characters are handled the same way. Input string that are enclosed within the square brackets are assigned to the Set token. The Set token may have a set of discrete characters, or a range of characters. When the values within a set are processed into a bit set that marks each individual character belonging to the set, the Set token is converted into a CharSet. Characters that are associated together using the “OR” operators in a grammar rule are also grouped into a CharSet.

Operator tokens are self-explanatory. These operators are used in a grammar rule to combine and mix the basic entities of a language to form a more complex one. Tokens that belong to this category are: OpExpInto; OpOr; and OpExclude. OpExpInto is the “::=” symbol in the EBNF notation. It indicates to the software that a sequence of tokens will immediately follow this token and they will form the expansion rule for the left hand side symbol that comes just before this token. OpOr is the “or” operator which is denoted by the “|” symbol in the EBNF notation. OpExclude is the “exclude” operator which is denoted by the “−” symbol in the EBNF notation. These two operators are described earlier in the Formal Grammar section.

Attribute tokens are used to describe the allowable occurrence frequency for a symbol in a particular rule for a language. The tokens in this category include: AttZeroOrOne; AttZeroOrMany; and AttOneOrMany. AttZeroOrOne is denoted by the “?” character in EBNF and it is used to indicate that the symbol that appears immediately before this token is an optional symbol. That optional symbol can appear zero or exactly one time in this particular context within the language. AttZeroOrMany is denoted by the “*” character in EBNF and it is used to indicate that the symbol that appears immediately before this token can occur zero or many times in the current context. While AttOneOrMany similarly allows the previous tokenized symbol to appear one or many times and the attribute is denoted by the “+” character in EBNF.

The Group category have two tokens defined: LParen and RParen. LParen signals the beginning of a group, while RParen indicates the end of a group. A group is defined by the expression enclosed by the left parenthesis and the right parenthesis. The entire expression within a group is treated as a unit. Groups may be embedded within another group.

The Misc category contains meta tokens. These tokens include BlockStart; BlockEnd; and RecExp. These tokens are inserted into the grammar rules stored in the internal production table primarily for debug purpose. As part of the state transition generation process, the grammar rules are expanded inline starting from the “language starting symbol” until all symbols becomes terminal symbols or recursive symbols. Recursive symbols are not expanded inline, of course, since recursive expansion would result in an infinite loop, as discussed above. To aid with debugging, the BlockStart and BlockEnd tokens are inserted into the resulting rule during the inline expansion to identify the beginning and the end of a rule segment within the expanded rule. The tokens contain the left hand side symbol name from the original input production rule to help with the identification. RecExp indicates a recursive expression.

The Unknown token category is a place holder category for the software to hold an unknown token temporarily while it is being resolved, or before it is reported to the users as an error.

The Token class provides the constructors and the following methods:

Token

equals

setToken

getcategory

isCategoryControl

isCategorySymbol

isCategoryOperator

isCategoryAttribute

isCategoryGroup

isCategoryMisc

print

The Token constructors and the setToken method allows the caller to construct a token from scratch. The caller may use the getCategory, equals, and the various isCategoryXXXX methods to perform inquiries on a token. The print methods will print all information related to a token to the screen.

RuleMgr

The RuleMgr class provides a facility to create and maintain the grammar production rules in a hash table known as the ruleTable. The right hand side expression of a grammar production rule is stored as a vector of tokens. The vector is saved into the hash table using the left hand side symbol of the production rule as the hash key.

The RuleMgr constructor provides a common mechanism to initialize the RuleMgr class. Other methods are provided by the RuleMgr class to help to construct the ruleTable, to make queries on the ruleTable, to perform conversions, and to support debugging. These methods are:

parseEBNFRules

checkRule

component Length

extractCharSet

replaceGroupsWithCharSets

convertCharSetEntities

findExclusion

findalternation

groupRightAltParam

groupLeftAltParam

groupAltParams

printRule

replaceRule

parseEBNFRules is an import method provided by the RuleMgr class. parseEBNFRules allows a caller to extract the grammar rule specification from an input grammar file. The method uses the passed in InputMgr to read the grammar file. It then reconstructs each of the production rules as a vector of tokens. The rules are saved into the ruleTable, and each rule is keyed by its left hand side symbol.

The method, checkRule, allows a caller to determine if a rule has already been defined in the ruleTable. This eliminates the need for the caller to access the hash table that implements the ruleTable directly.

Given a symbol name for a grammar rule, the method, componentLength, returns the number of tokens required to define the grammar rule. A typical use of this method is to determine if the rule has only a single component (for example: a set) in the grammar rule expression.

The method, extractCharSet, checks a segment of the token vector for a grammar production rule as specified by a pair of indices as the input, and determines if the expression subset can be resolved into a CharSet. The method will return the CharSet to the caller if the expression subset can be transformed into a CharSet. This method supports the convertCharSetEntities method.

The method, replaceGroupsWithCharSets, goes through the passed in vector containing a sequence of tokens and replace all suitable expression subsets with CharSets. This method supports the convertCharSetEntities method.

The method, convertCharSetEntities, goes through the entire ruleTable and transforms all sets and eligible expression subsets into CharSets.

The method, findExclusion, goes through the entire ruleTable and finds all grammar production rules that contain the “exclude” operator. At completion, the method returns those grammar rules in a vector.

The method, findalternation, goes through the entire ruleTable and finds all grammar production rules that contain the “OR” operator. At completion, the method returns those grammar rules in a vector.

The method, groupRightAltParam, adds a pair of parentheses around the sub-expression on the right hand side of the “OR” operator in a grammar rule if the sub-expression is not already grouped with parentheses.

The method, groupLeftAltParam, adds a pair of parentheses around the sub-expression on the left hand side of the “OR” operator in a grammar rule if the sub-expression is not already grouped with parentheses.

The method, groupAltParam, adds a pair of parentheses around the two sub-expressions on the each side of the “OR” operator in a grammar rule if the sub-expression is not already grouped with parentheses.

The method, printRule, provides debug support by printing the grammar rule that is named by the input left hand side symbol as a sequence of tokens to the screen.

The method, replaceRule, replaces the vector of tokens for a grammar rule as named by the input symbol.

ExpandedRule

The primary purpose of the ExpandedRule class is to provide a facility to expand the grammar rule starting from a starting symbol, and continuously expand all production rules inline until all rule symbols have been refined into CharSets, character string literals, or recursive symbols. CharSet and character string literals are terminal symbols which cannot be further refined. Recursive symbols require a stack to perform its state transition due to its nature of recursively entering the same state. A separate special process will be implemented to handle recursive symbols. For the purpose of rule expansion though, they are being treated as if they are terminal symbols.

Two constructors are provided to expand the grammar production rules contained in the passed in RuleMgr object. To accommodate independent processing of multiple rule tables, the RuleMgr is an input argument to the constructors. One other input argument required by the constructors is the “language starting symbol”. This gives the constructor a starting point to expand the rules. One of the two constructors also requires a Boolean flag argument to indicate if it is desirable to compress the resulting expanded production rule. The compression is carried out by avoiding the generation of tokens, especially Misc Tokens, that are generated primarily for debug purpose, and by aggressively transforming rule segments into CharSets. These constructors are the primary interfaces required by the callers to expand a grammar rule. The constructors will invoke the internal private methods to expand the production rules inline resulting in a single grammar rule that covers the entire language. In the process of expanding the rules, these methods will also identify recursive symbols. These recursive symbols are treated in the expansion effort as if they are terminal symbols. The recursive symbols are also saved away by the constructors into a table maintained by the RecursiveSymbolMgr for processing later. After the top level production rule has been expanded, the caller may invoke the “expandAllRS” method to expand all recursive symbols that were identified and saved away by the constructors.

The expandAllRS and performSimpleExclude methods are the only other external interface in the ExpandedRule class. The expandAllRS method gets a list of all recursive symbols from the RecursiveSymbolMgr class, and expands each recursive symbol one at a time. Similar to the top level expansion, any recursive symbols encountered during the expansion process will be treated as terminal symbols. These recursive symbols will cause special action code to be generated during the state transition table creation so that it can request a stack to support recursion.

The performSimpleExclude method goes through the expanded grammar rule to locate the “exclusion (−)” operators. For each one it encounters, if the operands of the exclusion operation are determined to be a CharSet with a character literal, or two CharSets, the method will perform the exclusion operation immediately, and replace the operation expression in the grammar rule with the resulting CharSet.

The rest of the methods in ExpandedRule are private methods. These methods are:

init

isOnTheStack

expand

expandRS

The init method helps the constructors to initialize the class variables and to kick off the grammar rule inline expansion processing.

The isOnTheStack method provides internal support for the constructors to determine if a grammar symbol is a recursive symbol. The software keeps track of the grammar symbols along the expansion chain by pushing each symbol being expanded onto the stack. Once the symbol is fully expanded, it is popped off the stack. Before expanding a symbol, the code checks if the symbol is already on the stack. If that is the case, the symbol is identified as a recursive symbol.

The expand method is a recursive method that performs inline expansion of grammar rules by obtaining the right hand side expression of each non terminal symbol it encountered and replacing the symbol with the expression. It begins with a starting symbol, and it continues the substitution with each symbol in the expanded rule until all symbols become terminal symbols or recursive symbols. A stack is used to identify all recursive symbols as described above in the isOnTheStack method.

The expandRS method is very similar to the expand method described above. It supports the expandAllRS method to expand the grammar rules specifically for recursive symbols. The expansion is done like the expand method by means of copying the vector of tokens that represent the production rule named by a non terminal symbol out of the ruleMgr, and replace that symbol in the rule being expanded with the vector of tokens. The process is repeated continuously until all symbols in the expanded rules are terminal symbols or recursive symbols. If a recursive symbol, including the symbol of the recursive rule that is being expanded itself, is encountered during the expansion, it is treated as if it is a terminal symbol.

CharSet

CharSet is a class that supports a set facility for storing the set of valid characters used in an expression in a grammar production rule or derived from a sub-expression in the grammar rule. Character sets initially specified in a production rule in EBNF are enclosed within a pair of square brackets. The contents within the square brackets may be expressed in a number of ways:

A sequence of characters containing all valid discrete characters

A range of characters

Individual characters expressed as hexadecimal values

A range of characters expressed using hexadecimal values

Outside the range notation

A combination of the above

Methods provided by the CharSet class will handle all these different ways of specifying a set of valid characters and convert them into a CharSet object transparently for the caller. Additional methods are available from the class allowing the caller to maintain a CharSet object.

There are two CharSet constructors available.

A parameter-less constructor allows the caller to set up a CharSet object with contents to be added at a later time. The other constructor allows the caller to set up a CharSet and initialize its contents by specifying a string that is formatted with information as described above.

The methods defined in the CharSet class are:

add

remove

isin

isEqual

print

charCount

iterator

There are three overloaded “add” methods. Each add method allows the caller to add more characters into a CharSet object. The first variant allows the caller to specify a number of characters using a string format as described above. The second add method allows a caller to add a character to the CharSet object. While the third variation allows a caller to copy the contents of another CharSet object into the current object.

There are two overloaded “remove” methods. The first version allows a caller to remove a character from the current CharSet object. The second version accepts a CharSet object as an input parameter. It removes all characters that are found in the input CharSet from the current CharSet object.

The isin method allows a caller to find out if a particular character is currently in the CharSet object.

The isEqual method compares another CharSet object with the current object to determine if they have the same contents.

The print method is provided for debug purpose. It print the current content of the CharSet object to the screen.

The charCount method returns the number of characters currently in the CharSet.

The iterator method returns an iterator object to the caller allowing the caller to access each of the characters inside the CharSet one at a time.

To support the iterator method, the CharSet class also contains an inner class, CharSetIterator.

CharSetIterator is an implementation of the Iterator interface.

RecursiveSymbolMgr

The RecursiveSymbolMgr maintains a hash table allowing the caller to set up a table to contain production rules that are recursive in nature. The recursive symbol table is used by the InputMgr, the ExpandedRule, and the NFAMgr classes. The class creates a Java hash table with the constructor. Since the table is implemented using a Java hash table, access to and maintenance of the recursive symbol table are performed using the hash table methods. The class does not define any additional methods.

RSEntry

The RSEntry class defines the structure of the entries for the Recursive Symbol Table that is implemented as a hash table in the RecursiveSymbolMgr class. The purpose of the class is to define the data structure. As such, only a constructor is provided to initialize the class variables. All fields in the data structure are directly accessible using their native methods.

NFAMgr

The NFAMgr class provides supports to transform an expanded grammar production rule into a non-deterministic finite automata (NFA). The NFAMgr class encapsulates a StateMgr class that is used for storing the state transition information generated from the expanded input grammar rule. The StateMgr is instantiated by the NFAMgr constructor. In addition to the constructor, the NFAMgr class also defines the following methods:

genStates

genNFA

findLoopbackState

checkAttributeNext

eliminateDoubleEpsilons

optimizeEpsilonTransitions

The genStates method allows the caller to start the processing to transform an expanded grammar rule into a non-deterministic finite automata. The input expanded grammar rule is passed in as a vector of tokens. The method then calls the recursive genNFA method to decompose the expanded grammar rules into manageable segments and converts these segments into state transitions.

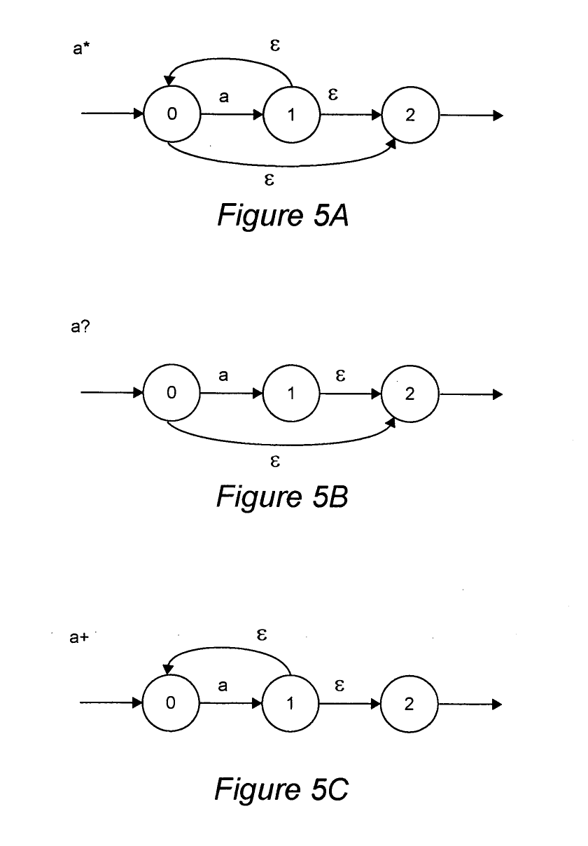

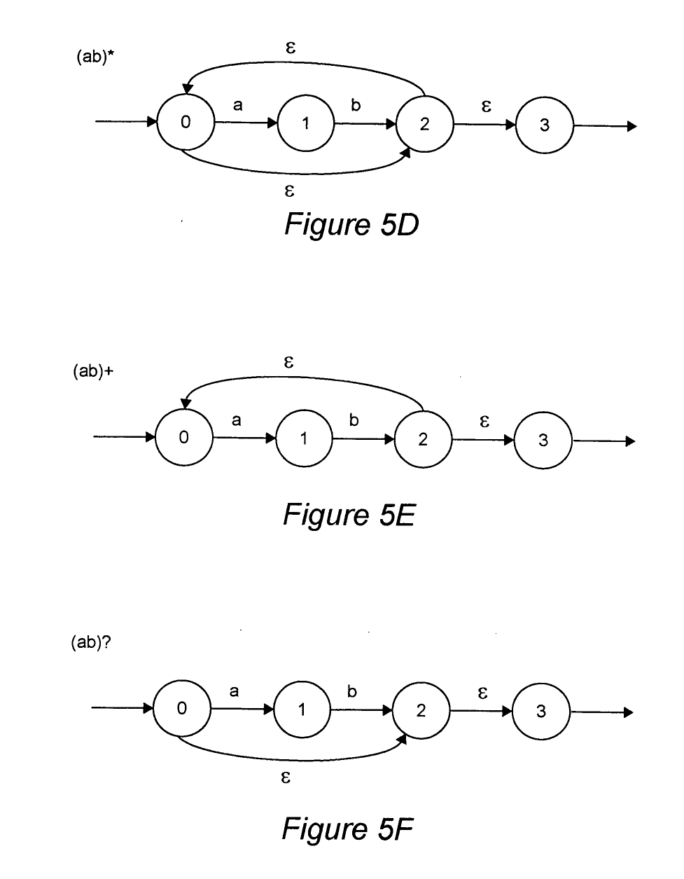

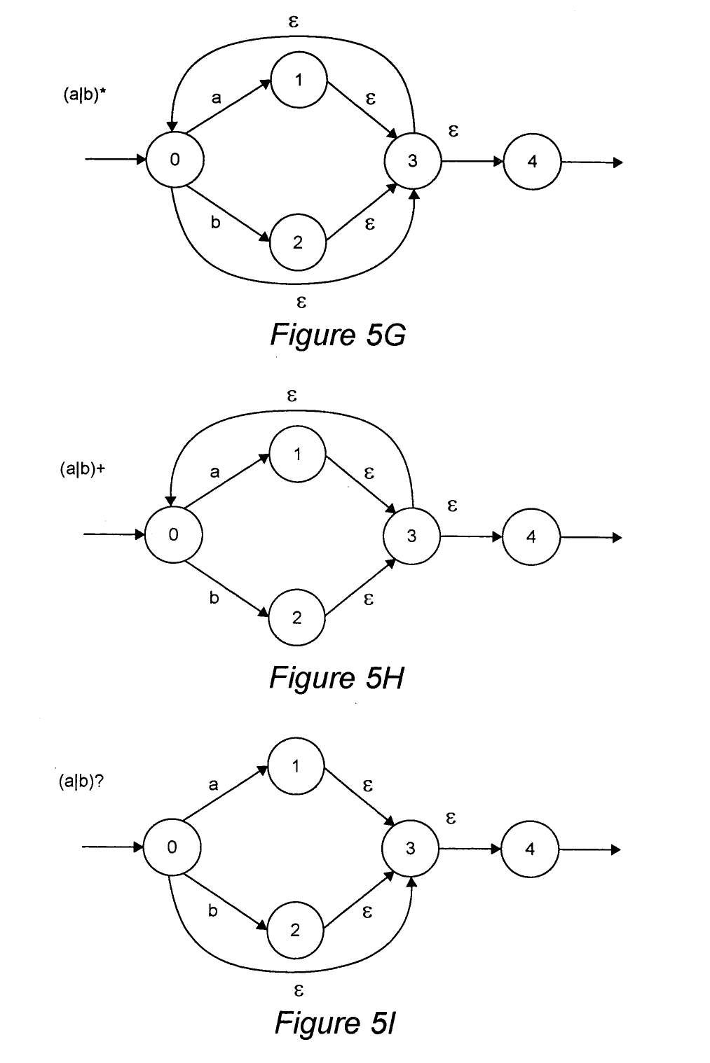

The genNFA method process a segment of the input expanded grammar rule at a time in a recursive fashion until the entire grammar rule is transformed into a complete non-deterministic finite automata. The processing is done by grouping and recognizing the common sub-expressions used in the grammar rule definition as illustrated in FIGS. 5A-5I.

FIGS. 5A-5I illustrate several commonly occurring language patterns described as non-deterministic finite automata (NFA) which are defined above by labels contained in the respective Figures. For Example, the pattern “a*”, representing zero or more occurrences of “a”, is illustated in FIG. 5A; the pattern “a?”, representing zero or one occurrences of“a” is illustrated in FIG. 5B, etc. This notation and logical processing of a corresponding pattern is a well-known technique used in compilers to concisely represent these patterns. However, since one input, such as the ε (epsilon, the empty input), can cause more than one state transition, such as in FIG. 5D, step 2), this representation must eventually be changed into deterministic finite automata (DFA), as alluded to above.

The transformation is preferably not done in the most optimized fashion at this point in order to come up with common state transition patterns to make it easy to group and combine the outcome from the grammar rule sub-expressions. Redundant states will be eliminated and common states will be combined once a complete NFA state transition sequence is created.

The findLoopbackState method supports the attribute (i.e., *+?) transformation processing in the checkAttributeNext method to determine the starting state for the current grammar sub-expression group so that one or more transition arcs can be added correctly for each of the attributes.

The checkAttributeNext method checks to find out if an attribute is defined for a grammar rule sub-expression that has just been transformed into a NFA sequence. If an attribute is found, it will add the appropriate transitions in the NFA to satisfy the attribute specification.

The eliminateDoubleEpsilons method optimizes the NFA transition sequence to remove redundant state transitions.

The optimizeEpsilonTransitions method removes extraneous transitions within the complete NFA state transition sequence.

StateMgr

The StateMgr class supports the creation and maintenance of a state transition table. It provide supports to both the NFAMgr class and the DFAMgr class. The class constructor initializes class variables and allocate storage for the state transition table. Additionally, the constructor creates a hash table that maps the NFA states (old states) to the DFA state (new state) to support the DFA transformation. Other methods defined in the StateMgr class are:

assignNewState

recyclestate

addStateTransition

removeStateTransition

getAllOutTransitions

getAllInTransitions

getEpsilonOutTransitions

getEpsilonInTransitions

getEpsilonArcs

getNonEpsilonOutTransitions

getNonEpsilonInTransitions

getNonEpsilonArcs

allocateEntry

recycleEntry

updateEntry

getEntry

locateState

printstatistics

printStateWithExt

printstate

listStatesWithNFAStateSet

listStatesWithClosureStateSet

peekNextNewStateNum

writeXMLOutput

The assignNewState method reserves a state table entry and returns the corresponding state number to be used for a new transition state.

The recycleState method allows a caller to release a state table entry back to the pool for reallocation.

The addStateTransition method creates a transition arc from the current state to the next state based on the input transition information. It also creates a reverse link from the next state back to the current state transparently for the caller.

The removeStateTransition method removes a transition arc between two states. It removes both the forward and the reverse links for the same transition between the two states.

The getAllOutTransitions method returns a list of all outbound transitions related to the specified state to the caller.

The getAllInTransitions method returns a list of all inbound transitions related to the specified state to the caller.

The getEpsilonOutTransitions method returns to the caller a list of outbound epsilon transitions, transitions that are caused by an “empty” input, related to the specified state.

The getEpsilonInTransitions method returns to the caller a list of inbound epsilon transitions related to the specified state.

The getEpsilonArcs method returns a list of transitions that are related to an epsilon input taken out from the passed in list of transitions. This method exists primarily to support the getEpsilonOutTransitions and the getEpsilonInTransitions methods.

The getNonEpsilonOutTransitions method returns to the caller a list of all outbound transitions that exclude the epsilon transitions related to the specified state.

The getNonEpsilonInTransitions method returns to the caller a list of all inbound transitions that exclude the epsilon transitions related to the specified state.

The getNonEpsilonArcs method returns a list of transitions that are not related to an epsilon input taken out from the passed in list of transitions. This method exists primarily to support the getNonEpsilonOutTransitions and the getNonEpsilonInTransitions methods.

The allocateEntry method allocates a state table entry off from the locally controlled vector of state table entries.

The recycleEntry method puts a state table entry to the list of state table entries that are to be reused.

The updateEntry method copies the state entry information into the appropriate location in the state table vector maintained internally within the StateMgr class object.

The getEntry method retrieves the information related to a state from the internal state table vector.

The locateState method provide supports to the DFA transformation. It will find a matching DFA state, if existed, that was created for a set of NFA states matching the input parameter.

The printStatistics method provides debug support. It prints out to the screen the usage information related to the internally controlled state table.

The printStateWithExt method provides debug support. It prints all information related to a state with additional information that was maintained to support DFA transformation.

The printstate method provides debug support. It prints all information related to a state.

The listStatesWithNFAStateSet returns a list of DFA states that include the specified NFA state set.

The listStatesWithClosureStateSet returns a list of states that are part of the epsilon closure.

The peekNextNewStateNum returns the state number to be assigned to the next new state.

The writeXMLOutput method supports writing the state table out to an output file stream in the XML format.

StateEntry

The StateEntry class defines the content of a state table entry. A state entry contains three major fields: state number, a list of outgoing transition arcs, and a list of incoming transition arcs. There are two additional fields defined to support the DFA transformation: a set of NFA states that are being replaced, and a set of empty input transition closure states. The class constructor initializes the fields and creates the vectors for the outgoing and incoming arcs. The support the creation and maintenance of state table entries, the class also defines the following methods:

addToArc

addFromArc

removeToArc

removeFromArc

doesTransitionExist

removeArc

compareNFAStates

printToArcs

printFromArcs

printArc

printExtension

isInNFAStateSet

isInClosureStateSet

writeXMLOutput

The addToArc method adds an outgoing transition entry for the current state to the outgoing transition arc vector.

The addFromArc method adds an incoming transition entry for the current state to the incoming transition arc vector.

The removeToArc method removes an outgoing transition entry for the current state from the outgoing transition arc vector.

The removeFromArc method removes an incoming transition entry for the current state from the incoming transition arc vector.

The doesTransitionExist method allows the caller to do an inquiry to determine if the specified transition matches any of the transition entries in the outgoing transition arc vector.

The removeArc method supports both the removeToArc and the removeFromArc methods to remove a particular transition entry from the passed in transition arc vector.

The compareNFAStates method compares if the input set of NFA states matches the set of NFA states that are being replaces by the current DFA state.

The printToArcs method provides debug support to print out the information of all outgoing transition arcs for the current state.

The printFromArcs method provides debug support to print out the information of all incoming transition arcs for the current state.

The printArc method supports both the printToArcs and the printFromArcs methods to print out to the screen all transition entry information stored in the passed in transition arc vector.

The printExtension method provides debug support to print out the DFA transformation support information maintained in the state entry to the screen.

The isInNFAStateSet method provides support to the DFA transformation to check if a particular NFA state is already included in the NFA state set maintained within the current state entry.

The isInClosureStateSet method provides support to the DFA transformation to check if a particular NFA state is already included in the empty input closure state set maintained within the current state entry.

The writeXMLOutput method supports writing a state table entry out to an output file stream in the XML format.

TransitionEntry

The TransitionEntry class defines the data fields for information describing the transition arc going from one state to another. The information includes the type of the input that is causing the state transition; the actual value of the input that is causing the state transition; and the state number of the next state caused by this transition. There are six class constructors available to initialize and set up the input data information in the appropriate data fields so that the transition entry is ready for use. These constructors have different input parameters to match the transition input data types. The following methods are defined for the TransitionEntry class allowing the caller to access and to update the data fields:

clear

setSymbolName

setInput

setTransition

setCheckedFlag

getInputType

getCharSet

getInputChar

getTransition

getSymbolName

getCheckedFlag

isEqual

compareInput

copyinput

print

writeXMLCharInput

writeXMLOutput

The clear method set all data fields to an initial known state.

The setSymbolName method sets the transition input type to “RELOCATE” as an indication that a branch to another state table may be needed to handle a recursive symbol. The name of the symbol is passed in as an input parameter and is saved in the symbol name field for reference later.

The setinput methods are made up of three overloading methods, differing only in their input parameters. The first version of setinput does not require any input. It sets the transition input type for the transition entry as an empty (epsilon) input. The second version requires a character input parameter. The method sets the transition entry input type to character type, and save away the input character value. The third version requires a CharSet input parameter. It sets the transition entry input type to CharSet, and saves the CharSet value away.

The setTransition method allows the caller to specify the state number to go to for the transition.

The setCheckedFlag method supports the DFA transformation. It allows the DFA transformation processing to mark this transition entry so that this entry is only processed once to expedite the transformation.

The getInputType method returns the input type of this transition entry to the caller.

The getCharSet method returns the input CharSet value of this transition entry to the caller.

The getInputChar method returns the input character value of this transition entry to the caller.

The getTransition method returns the transition state number that is specified in this transition entry.

The getSymbolName method returns the value of the input symbol stored in this entry to the caller.

The getCheckedFlag method returns the current flag setting for the CheckedFlag in this entry to the caller.

The isEqual method compares all values including the transition state information stored in the transition entry that is passed in as an input parameter with those stored in this transition entry. It returns true if the values are the same; false otherwise.

The compareinput method compares the input type and the input value stored in the transition entry that is passed in as an input parameter with the input type and the input value stored in this transition entry. It returns true if the values are the same; false otherwise.

The copyinput method allows a caller to copy the input type and the input value information from a transition entry that is passed in as an input parameter to the current entry.

The print method provides debug support to print out the content of this transition entry to the screen.

The writeXMLCharInput method supports the writeXMLOutput method by determining if the input character is a printable ASCII character and write it out to the output file stream in the appropriate XML format.

The writeXMLOutput method supports writing the state transition information out to an output file stream in the XML format.

DFAMgr

The DFAMgr class supports the transformation of a Non-deterministic Finite Automata (NFA) into a Deterministic Finite Automata (DFA). The DFAMgr class constructor accepts a NFAMgr which contains the NFA state table to be transformed into a DFA as an input. The constructor also requires two additional parameters to specify the NFA starting state and the NFA final state so that the DFAMgr can map them into the DFA starting state and the DFA final states. The constructor creates a new StateMgr to maintain the new DFA states to be generated. After a DFAMgr class object is constructed, the caller can invoke the NFA2DFA method to perform the DFA transformation. The following is a list of methods defined by the DFAMgr:

createDFAState

NFA2DFA

addEpsilonOutStates

eClosure

getNFATransitionSet

extractNFAInputSet

extractNFATargetStateSet

findDFAFinalStates

printFinalStates

writeXMLOutput

The createDFAState method provide supports to the NFA2DFA method to perform DFA transformation. It creates a state table entry for a new DFA state. After the state entry is created, the method initializes the entry with the associated NFA state set and the epsilon closure set.

The NFA2DFA method is the primary method for performing the transformation from a NFA into a DFA. It employs some of the commonly known compiler construction techniques to transform a NFA into a DFA.

The addEpsilonOutStates is a recursive method that exists to support the eClosure method. The method adds epsilon (empty input) transition states in a recursive manner to the closure set originated from a set of NFA states that is mapped to a DFA state.

The eClosure method builds and returns a set of epsilon closure states that are associated with the set of NFA states passed in as an input parameter.

The getNFATransitionSet method builds and returns a set of non-epsilon transition entries that are associated with the set of states which are passed in as an input parameter.

The extractNFAInputSet method looks at a set of transition entries that are passed in as an input parameter, and returns a set of input extracted from these transition entries to the caller.

The extractNFATargetStateSet method looks at a set of transition entries that are passed in as the first input parameter, and returns a set of target states that have input matching the input specified in the transition entry which is passed in as the second input parameter for this method.

The findDFAFinalStates method returns a set of DFA states that are designated as the allowable final states in the DFA state table. The set is determined based on the original NFA final state which is passed in as an input parameter.

The printFinalStates method provides debug support to print out to the screen the set of DFA final states as determined by the NFA2DFA method.

The writeXMLOutput method supports writing the state table corresponding to the Deterministic Finite Automata created by the DFAMgr out to an output file stream in the XML format.

Referring to FIG. 6, an example of the state transition specification output represented as an XML file is shown there. The file header at 600 identifies the contents of the file, the date it was generated, and the source of the grammar rules input. The next section of the file at 610 provides some general information about the identity and the layout of the state table being specified. At 611, it identifies the number of logical state tables described in this file. These logical state tables can be combined into one single physical state table by the loader by appending the states from the subsequent logical state tables to the first one and adjusting their transitions accordingly. (For example, if the current last state in the physical state table is 1205. The next available state entry in the physical state table is 1206. To append the next logical state table to the physical state table, the initial state, which was logically labelled as state 0, is loaded to the physical state table entry 1206. All state transitions from the logical state table will be adjusted with an offset of 1206. Therefore, if there were a transition to State 5 of the logical state table, the transition will become 1211 (1206+5) in the physical state table.) At 612, it identifies the names of the logical tables. The recursive symbols themselves are used as the name for the logical state tables for the recursive symbols. At 613, it provides information to label the column (state input) of the physical state table. The next segment of the file at 620 provides detailed specification for each of the logical state tables. The section at 621 provides a complete description of a logical state table specified by this file. It identifies the table by name at 622. It then identifies the logical initial state for this state table at 623. The allowable final states are listed at 624. The number of states for this logical state table is specified at 625. Detailed information of all the different states for this logical state table and their transitions are identified in the section of the file at 626. It first provides a logical state number as shown at 627. And then it lists all transitions originated from this state with their input at 628. The states that have a transition into this logical state are identified at 629. The section of the file at 626 is repeated for each state in the logical state table. And the information specified at 621 is repeated for each of the logical state tables. This provides the complete information to the loader to personalize the hardware accelerator.

In view of the foregoing, it is seen that the invention can directly and automatically provide error-free state table data for any computer language or for other purposes from a language or function specification, preferably in a formal notation such as BNF or its derivative. The process is rapidly executable and results in error-free state table data at low cost. Thus the invention allows a personality for a FSM to be rapidly changed, at will, to accommodate or provide different functions or reflect different languages or character stings of interest.

While the invention has been described in terms of a single preferred embodiment, those skilled in the art will recognize that the invention can be practiced with modification within the spirit and scope of the appended claims.

Having thus described my invention, what we claim as new and desire to secure by letters patent is as follows:

1. A method of providing state tables in a self-describing format, said method comprising steps of
providing a specification of performable functions,
discriminating tokens corresponding to respective ones of said performable functions,
transforming tokens into deterministic finite automata, and
transforming said deterministic finite automata into state table entries.

2. The method as recited in claim 1, wherein said step of transforming said deterministic finite automata includes forming a character string.

3. The method as recited in claim 1, including a further step of
detecting grammar entities in said specification of performable functions which express special rules.

4. The method as recited in claim 3, wherein said special rules include exclusion.

5. The method as recited in claim 3, wherein a detected grammar entity is recursive.

6. The method as recited in claim 5, including further step of
generating a set of finite automata corresponding to a recursive grammar entity.

7. The method as recited in claim 5, including the further step of storing a recursive symbol in a recursive symbol table.

8. The method as recited in claim 5, wherein a recursive grammar entity is a delimiter symbol.

9. The method as recited in claim 1, wherein said step of transforming tokens includes a further step of
detecting non-deterministic finite automata corresponding to respective ones of said tokens.

10. The method as recited in claim 9, wherein said step of transforming tokens includes a further step of
transforming non-deterministic finite automata into deterministic finite automata.

11. The method as recited in claim 10, wherein said step of transforming non-deterministic finite automata includes a further step of
forming a closure set from states of said non-deterministic finite automata.

12. The method as recited in claim 5, wherein said step of transforming tokens includes a further step of
detecting non-deterministic finite automata corresponding to respective ones of said tokens.

13. The method as recited in claim 12, wherein said step of transforming tokens includes a further step of
transforming non-deterministic finite automata into deterministic finite automata.

14. The method as recited in claim 13, wherein said step of transforming non-deterministic finite automata includes a further step of
generating a closure set from states of said non-deterministic finite automata.

15. The method as recited in claim 1, including a further step of optimizing deterministic finite automata.

16. The method as recited in claim 6, including a further step of optimizing deterministic finite automata.

17. The method as recited in claim 10, including a further step of optimizing deterministic finite automata.

18. The method as recited in claim 1, wherein said steps of transforming tokens and transforming deterministic finite automata are performed as a single non-branching sequence.

19. A personality compiler comprising
means for inputting a specification of functions performable by a data processor, said specification including grammar entities,
means for generating finite automata from tokens in said specification, including means for generating a set of finite automata for recursive grammar entities,
means for generating a closure set from states of non-deterministic finite automata to form deterministic finite automata, and
means for transforming said deterministic finite automata into state table entries to define a finite state machine.

20. The personality compiler as recited in claim 19, further including
a loader for loading said state table entries into said finite state machine, said loader including a stack for storing and outputting said sets of finite automata corresponding to said recursive grammar entities.

21. A hardware parser accelerator including
a finite state machine,
a loader for loading state table data into said finite state machine, and
a personality compiler comprising
means for inputting a specification of functions performable by a data processor, said specification including grammar entities,
means for generating finite automata from tokens in said specification, including means for generating a set of finite automata for recursive grammar entities,
means for generating a closure set from states of non-deterministic finite automata to form deterministic finite automata, and
means for transforming said deterministic finite automata into state table entries to define a finite state machine.

22. A hardware parser accelerator as recited in claim 21, wherein said loader includes
a stack for storing and outputting said sets of finite automata corresponding to said recursive grammar entities.

23. A hardware parser accelerator as recited in claim 21, wherein the personality compiler and loader operate in substantially real time to alter state tables of said finite state machine.

24. A hardware parser accelerator as recited in claim 23, wherein loading of said finite state machine adapts said parser accelerator and said personality compiler over time responsive to conditions observed in an input data stream.

25. A hardware parser accelerator as recited in claim 21, wherein a portion of said personalty compiler is operated when said hardware parser accelerator is off-line and provides storage for results in the form of either finite automata or state tables and said loader is operated on an on-demand basis.
